(19) United States
(12) Patent Application Publication
(10) Pub. No.: US 2011/0050444 A1
(43) Pub. Date: Mar. 3, 2011

(54) Person/Worker/Device Proximity Warning System

(75) Inventor: Robert Eugene Stull, East Wenatchee, WA (US)

(73) Assignee: Robert E. Stull

(21) Appl. No.: 12/551,519

(22) Filed: Aug. 31, 2009

(51) Int. Cl. G08B 21/00

(52) U.S. Cl. 340/686.6

(57) ABSTRACT

A Person/Worker/Device Proximity Warning System of a type including a clip-on or pocket sized radio frequency or infrared pocket transmitter, an externally mounted radio frequency or infrared antenna receiver, and an audible and visual warning system, which is connected by circuitry to the antenna receiver. The audible and visual warning system is capable of being turned on and alerts a driver/operator when the transmitter is within proximity of the antenna mounted inside the drivable heavy equipment, machinery, truck, or vehicle.

### FIELD OF THE INVENTION

The present invention relate to the field of construction work, construction workers, and construction equipment and vehicles and a system for informing equipment operators and truck drivers when a person (worker) is within proximity of or in the driving path of a heavy vehicle.

### BACKGROUND OF THE INVENTION

Small radio and infrared devices are used on a regular basis, e.g. ADA technology (radio operated chairs and switches) and television remote controls. In my field of work, I design intelligent transportation systems where communication often takes place with radio equipment.

I work for the Washington State Department of Transportation (WSDOT) where employee safety is high priority. During a department wide safety meeting, a video was presented, which had an employee discuss how he was backed over by a traffic control, truck mounted impact attenuator. While he was discussing the scenario, I thought that if the employee was wearing a small radio transmitter and the truck had a receiver that could activate an alarm inside the truck cab, the driver would have heard the alarm and stopped the vehicle, before the worker was backed over. After the video was completed, I mentioned by idea fellow employee and friend, because I thought that this idea could save lives and I decided to pursue developing the idea.

I further discussed this idea with another fellow employee, who works as a radio technician for the WSDOT, to see if this idea was feasible. After a brief discussion, I figured that the idea could be developed.

### SUMMARY OF THE INVENTION

Based in the previous discussion, the intent of the invention is to create a system that can alert a driver or operator of construction equipment that a worker or person is in dangerous proximity of the equipment being operated.

The features of this present invention comprise of a pocket radio or infrared transmitter that can be attached to an article of clothing, such as a safety vest, either by clipping the transmitter onto the clothing article or by placing the transmitter into a pocket located on the clothing article.

Further, the system includes a radio or infrared antenna receiver that can be mounted to the top or back of the vehicle, which when it receives the signal from the pocket transmitter an alarm system mounted inside the driver/operator compartment will alert the driver/operator of the presence of the transmitter being worn by a work/person.

Further, the system includes a surface or in dash mounted alarm system that provides audible and visual warning signals for the purpose of alerting the equipment driver/operator so the driver/operator can take necessary action to avoid injury or death to a person/worker.

Further, the transmitter can be attached to a device or equipment, such as surveying equipment or a smaller vehicle working within the proximity of a larger vehicle.

Further, the transmitter, receiver, and warning device can be powered by a direct current power source such as battery(ies) or by a small solar panel.

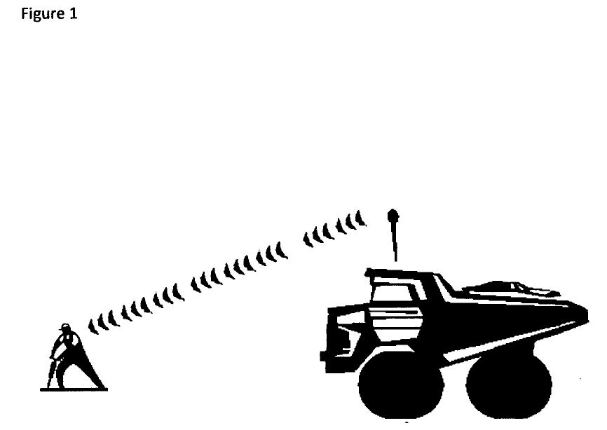

FIG. 1, is an illustration of a worker with the radio transmitter in place, on his person. The piece of heavy equipment is shown with the antenna mounted on the top of vehicle and a signal is being transmitted from the worker's transmitter and received by the vehicle's antenna.

1. A Person/Worker/Device Proximity Warning System consisting of a small (pocket sized) radio frequency or infrared transmitter, which can be clipped onto clothing or placed in a pocket that is capable of transmitting a signal over a viable distance, up to 100′; an antenna receive, which can be mounted externally to drivable heavy equipment, machinery, truck, or vehicle that can receive an radio frequency or infrared signal from 360° or from a variable direction consisting of 1°≦distance≦360°; and a visual and audible warning indicator, capable of a lighted, steady burning or flashing, warning and an audible sound, connected to the antenna receiver by circuit, which is mounted to the passenger/operator compartment of the vehicle, such that when the radio frequency or infrared transmitter is within proximity of the antenna receiver/drivable heavy equipment, machinery, truck, or vehicle the warning indicator is turned on alerting the driver/operator.

2. The Person/Worker/Device Proximity Warning System of claim 1 wherein the transmitter comprises of a programmable electronic radio frequency or infrared transmitter.

3. The Person/Worker/Device Proximity Warning System of claim 2 wherein the transmitter is built into a housing, which can be clipped or pinned onto an article of clothing or device, or placed into a pocket or bag.

4. The Person/Worker/Device Proximity Warning System of claim 3 wherein the article of clothing, pocket, or bag can be worn by a person, animal, or attached to a device, which needs to be monitored by the driver/operator of a drivable heavy equipment, machinery, truck, or vehicle.

5. The Person/Worker/Device Proximity Warning System of claim 2 wherein can be powered by dc current provided by batteries or solar panel.

6. The Person/Worker/Device Proximity Warning System of claim 5 wherein can be provide an output signal of varied power so as to be received by an antenna receiver a varied distance of up to 100′.

7. The Person/Worker/Device Proximity Warning System of claim 1 comprises of a radio frequency or infrared receiver, which can be externally mounted to the housing or frame of a drivable heavy equipment, machinery, truck, or vehicle.

8. The Person/Worker/Device Proximity Warning System of claim 7 comprises of a direct current powered antenna capable of being powered by the heavy equipment, machinery, truck, or vehicle power system or by solar panel.

9. The Person/Worker/Device Proximity Warning System of claim 8 comprises of an electronic radio frequency or infrared transmitter, which is capable of receiving a signal from a 360° direction or from a variable direction consisting of 1°≦distance≦360°.

10. The Person/Worker/Device Proximity Warning System of claim 1 comprises of an audible and visual alarm/warning device, which can be mounted to the inside of the driving/operating compartment of a drivable heavy equipment, machinery, truck, or vehicle.

11. The Person/Worker/Device Proximity Warning System of claim 10 comprises of a connection to the vehicle circuitry such that the system is turned on when the drivable heavy equipment, machinery, truck, or vehicle is powered up.

12. The Person/Worker/Device Proximity Warning System of claim 11 comprises of an audible and visual warning device which is activated when the radio frequency or infrared antenna receiver receives a signal from the transmitter of claim 2.

13. The Person/Worker/Device Proximity Warning System of claim 12 comprises of circuitry connecting the warning device to the antenna receiver of claim 7.

14. The Person/Worker/Device Proximity Warning System of claim 13 comprises of a direct current powered warning device capable of being powered by the heavy equipment, machinery, truck, or vehicle power system or by solar panel.

15. The Person/Worker/Device Proximity Warning System of claim 14 capable of an audible warning system of variable volumes 0 to 90 dB.

16. The Person/Worker/Device Proximity Warning System of claim 14 capable of emitting a lighted warning system by utilizing a LED lighting source or an incandescent bulb.
